(19) United States
(12) Patent Application Publication
(10) Pub. No.: US 2012/0308449 A1
(43) Pub. Date: Dec. 6, 2012

(54) BIOCHIP

(75) Inventors: Jeong Suong YANG, Yongin (KR); Bo Sung Ku, Suwon (KR)

(73) Assignee: SAMSUNG ELECTRO-MECHANICS CO., LTD.

(21) Appl. No.: 13/335,039

(22) Filed: Dec. 22, 2011

(30) Foreign Application Priority Data
Jun. 3, 2011 (KR) 10-2011-0053935

(51) Int. Cl. B01L 3/00

(52) U.S. Cl. 422/559

(57) ABSTRACT

There is provided a biochip including: a hydrophilic first substrate including a plurality of micro wells formed therein at predetermined intervals; a hydrophobic barrier layer formed on a surface of the hydrophilic first substrate; and a hydrophobic second substrate including biomaterials formed thereon, the biomaterials being inserted into the micro wells by joining the hydrophilic first substrate and the hydrophobic second substrate.

### CROSS-REFERENCE TO RELATED APPLICATIONS

This application claims the priority of Korean Patent Application No. 10-2011-0053935 filed on Jun. 3, 2011, in the Korean Intellectual Property Office, the disclosure of which is incorporated herein by reference.

### BACKGROUND OF THE INVENTION

1. Field of the Invention

The present invention relates to a biochip, and more particularly, to a biochip having excellent measurement efficiency and accuracy.

2. Description of the Related Art

The demand for biomedical devices and biotechnology for rapidly diagnosing various human diseases has recently increased. Accordingly, the development of a biosensor or a biochip capable of providing diagnostic results for a specific disease that have previously required a long period of time to be performed in a hospital or a research laboratory, has been actively conducted.

Research into a biosensor or a biochip has also been demanded in pharmaceutical companies, cosmetics companies, and the like, in addition to hospitals. In the fields of pharmaceuticals, cosmetics, and the like, a method of verifying the effectiveness and stability (toxicity) of a specific drug by inspecting the reaction of a cell to the specific drug has been used. Since the method according to the related art requires the use of animals or a large amount of reagent, testing costs and time have increased.

Accordingly, there is a need for the development of a biosensor or a biochip capable of rapidly and accurately diagnosing diseases, while simultaneously reducing the costs thereof.

The biochip may be divided into a DNA chip, a protein chip, and a cell chip, according to the kinds of biomaterials fixed to a substrate thereof. In the early stages of the development of this technology, as the understanding of the human genome has increased, the DNA chip has been significantly prominent. However, as interest in proteins maintaining vital activity and a protein conjugate cell, which becomes the core of living things, has increased, interest in a protein chip and a cell chip has increased correspondingly.

The protein chip initially had difficulties such as non-selective adsorption. However, methods for solving difficulties such as this have recently been suggested.

The cell chip, which is an effective medium capable of being applied to various fields such as new medicine development, genomics, proteomics, and the like, has also been prominent.

### SUMMARY OF THE INVENTION

An aspect of the present invention provides a biochip having excellent measurement efficiency and accuracy.

According to an aspect of the present invention, there is provided a biochip including: a hydrophilic first substrate including a plurality of micro wells formed therein at predetermined intervals; a hydrophobic barrier layer formed on a surface of the hydrophilic first substrate; and a hydrophobic second substrate including biomaterials formed thereon, the biomaterials being inserted into the micro wells by joining the hydrophilic first substrate and the hydrophobic second substrate.

The hydrophobic barrier layer may include portions formed on portions of the surface of the hydrophilic first substrate.

The hydrophobic barrier layer may include a plurality of portions having a predetermined size and formed on the surface of the hydrophilic first substrate at predetermined intervals.

The hydrophobic barrier layer may include a plurality of portions having a predetermined size and formed between the micro wells.

The hydrophobic barrier layer may be formed over an entire surface of the hydrophilic first substrate in which the micro wells are formed.

The hydrophilic first substrate maybe made of at least one polymer selected from the group consisting of polymethylmethacrylate, polycarbonate, and polyethylene.

The hydrophilic first substrate maybe made of at least one polymer selected from the group consisting of polymethylmethacrylate, polycarbonate, and polyethylene.

The hydrophobic second substrate may be made of at least one polymer selected from the group consisting of polystyrene, polycarbonate, polyethylene, and poly(styrene-maleic anhydride).

The biomaterials may be present on the hydrophobic second substrate in a state in which the biomaterials are dispersed in a porous dispersion medium.

The hydrophobic second substrate may include a plurality of micro fillers formed thereon at predetermined intervals, and the micro fillers may include the biomaterials formed on a surface thereof.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view showing a biochip according to an embodiment of the present invention;

FIG. 2 is a schematic cross-sectional view showing a first substrate according to an embodiment of the present invention;

FIG. 3 is a schematic cross-sectional view showing a second substrate according to an embodiment of the present invention;

FIG. 4 is a schematic cross-sectional view showing a state in which first and second substrates configuring a biochip according to an embodiment of the present invention are joined with each other; and

FIG. 5 is a schematic cross-sectional view showing a biochip according to another embodiment of the present invention.

### DETAILED DESCRIPTION OF THE PREFERRED EMBODIMENT

Embodiments of the present invention will now be described in detail with reference to the accompanying drawings. The embodiments of the present invention maybe modified in many different forms and the scope of the invention should not be limited to the embodiments set forth herein. Rather, these embodiments are provided so that this disclosure will be thorough and complete, and will fully convey the concept of the invention to those skilled in the art. In the drawings, the shapes and dimensions may be exaggerated for clarity, and the same reference numerals will be used throughout to designate the same or like components.

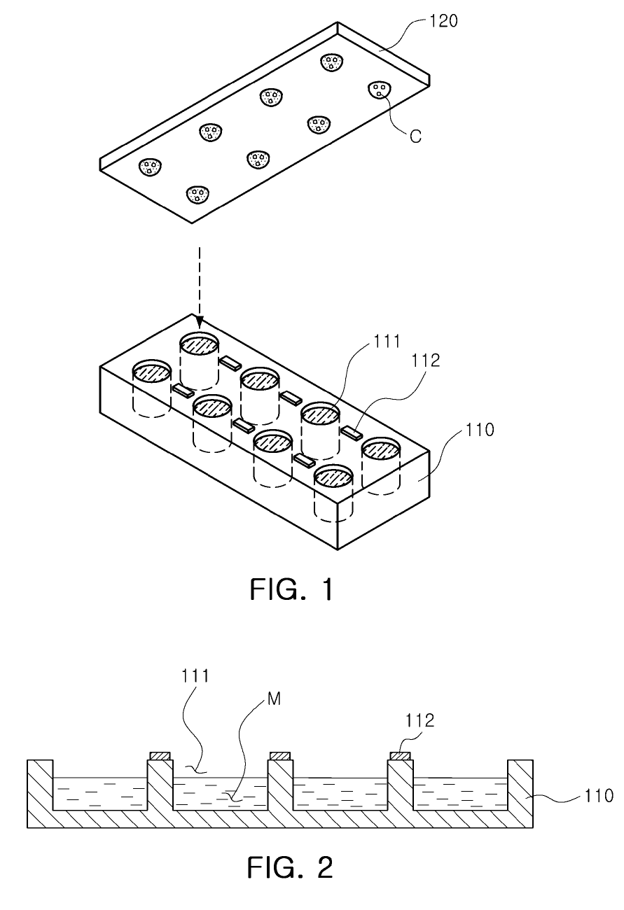

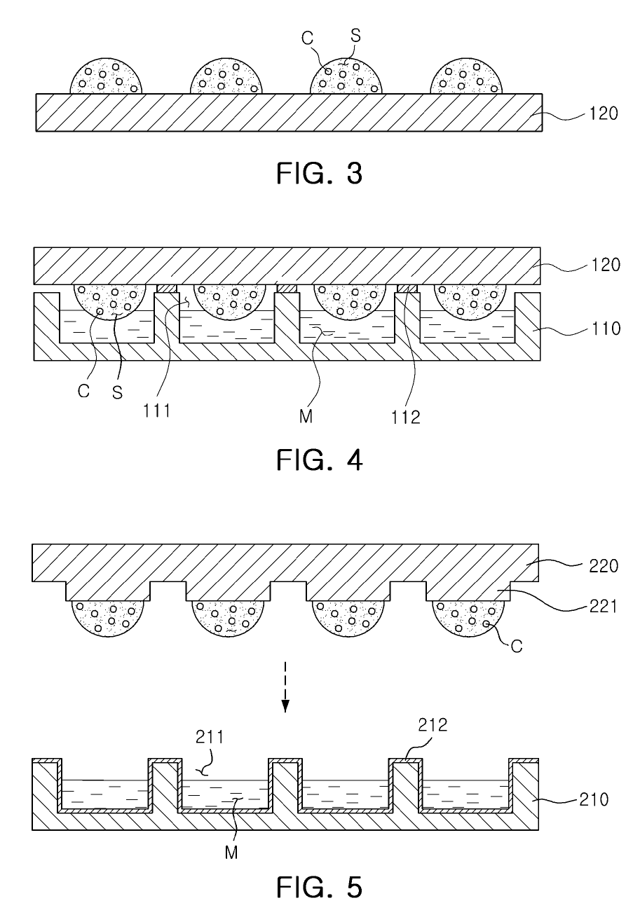

FIG. 1 is a schematic perspective view showing a biochip according to an embodiment of the present invention. FIG. 2 is a schematic cross-sectional view showing a first substrate according to an embodiment of the present invention; and FIG. 3 is a schematic cross-sectional view showing a second substrate according to an embodiment of the present invention. FIG. 4 is a schematic cross-sectional view showing a state in which first and second substrates configuring a biochip according to an embodiment of the present invention are joined.

Referring to FIGS. 1 through 4, a biochip according to an embodiment of the present invention may include a hydrophilic first substrate 110 and a hydrophobic second substrate 120. The hydrophilic first substrate 110 may include a hydrophobic barrier layer 112 formed on a surface thereof.

As shown in FIG. 2, the hydrophilic first substrate 110 may include a plurality of micro wells 111 formed therein at predetermined intervals. The micro well 111, which is formed to a predetermined depth from one surface of the first substrate, may be understood as a fine hole. The micro well 111 may have a diameter on a micro scale. The micro well may have a diameter of 50 to 1000 μm. However, a diameter of the micro well is not limited thereto. In addition, the micro wells may be formed so as to have high integration in the first substrate 110 and have an interval of 50 to 1000 μm therebetween. However, an interval between the micro wells is not limited thereto.

A reagent M may be injected into the micro well 111. The reagent M is not specifically limited but may be, for example, a cell culture medium, a specific drug or various aqueous solutions.

The first substrate 110 may be made of a material having hydrophilicity, for example, a polymer. However, a material of the first substrate 110 is not limited thereto. As a specific kind of the polymer, for example, polymethylmethacrylate (PMMA), polycarbonate (PC), polyethylene, or the like, or a mixture thereof may be used. However, a kind of the polymer is not limited thereto. In addition, by adjusting a mixing ratio of the polymer, the first substrate may be formed to have desired characteristics.

Various reagents may be immersed in the micro wells 111 formed in first the substrate 110.

When biomaterials are inserted into the micro wells, various reagents may be directly supplied to the biomaterials. Therefore, cells may be cultured, and the characteristics of the biomaterials according to the reagents may be analyzed to thereby perform various tests. In culturing the cells or testing reaction of the biomaterials for the reagents, the first substrate 110 may be kept in an environment having a range of varying temperatures such as room temperature or more, room temperature or less, or the like, for a long time. The first substrate 110 may be exposed to temperatures in the range of −80° C. to 25° C., or the like, without being limited thereto.

When the substrate is in a situation of a low temperature or in a situation in which a temperature is severely changed, it is deformed, such that accuracy of a test maybe deteriorated.

However, the first substrate 110 according to the embodiment of the present invention is made of a hydrophilic polymer, such that it may not be bent or deformed even if a severe temperature change occurs. Therefore, even in the case that a testis performed in various temperature ranges, the accuracy of the test may not be deteriorated and the measurement efficiency thereof may be improved.

The first substrate 110 may include the hydrophobic barrier layer 112 formed on a surface thereof. The hydrophobic barrier layer 112 may be made of a material having hydrophobicity, for example, a polymer. However, a material of the hydrophobic barrier layer 112 is not limited thereto. As a specific kind of the polymer, for example, polytetrafluoroethylene (PTFE), polystyrene, or the like, or a mixture thereof may be used. However, the polymer is not limited thereto. In addition, by adjusting a mixing ratio of the polymer, the hydrophobic barrier layer may be formed to have desired characteristics.

As shown in FIGS. 1 through 4, a plurality of portions of the hydrophobic barrier layer 112 may be formed on portions of a surface of the first substrate 110. The plurality of portions of the hydrophobic barrier layer 112 having a predetermined size may be formed on the surface of the first substrate. According to the embodiment of the present invention, the hydrophobic barrier layer 112 may have a thickness of 10 to 200 μm.

As shown in FIGS. 1 through 4, the portions of the hydrophobic barrier layer 112 may be formed between the micro wells. In addition, the hydrophobic barrier layer 112 may be formed to have various shapes on the surface of the first substrate, without being limited thereto.

According to the embodiment of the present invention, the hydrophilic first substrate 110 may be protected from the reagent by the hydrophobic barrier layer 112. A detailed description thereof will be provided below.

As shown in FIG. 3, the hydrophobic second substrate 120 may have biomaterials C present thereon. The biomaterials C may be arranged in a matrix form on the second substrate 120 at predetermined intervals. The biomaterials C may be formed on positions of the second substrate 120 corresponding to positions of the micro wells 111 formed in the first substrate 110 and may have a shape which may be inserted into the micro wells 111 formed in the first substrate 110.

The biomaterials C may be formed so as to have high integration on the second substrate 120 and have an interval of 50 to 1000 μm therebetween. However, an interval between the biomaterials is not limited thereto.

According to the embodiment of the present invention, the biomaterials C may be attached to the second substrate 120 in a state in which they are dispersed in a dispersion medium S capable of maintaining organization and functions of the biomaterials.

A kind of biomaterial C is not specifically limited but may be, for example, a nucleic acid arrangement such as RNA, DNA, or the like, a peptide, a protein, a fatty, organic or inorganic chemical molecule, a virus particle, a prokaryotic cell, an organelle, or the like. In addition, a kind of cell is not specifically limited, and may be, for example, a microorganism, a plant or an animal cell, a tumor cell, a neural cell, an endovascular cell, an immune cell, or the like.

The dispersion medium S may be a porous material through which a reagent M such as culture medium, a specific drug, various aqueous solutions, or the like, may penetrate.

As the dispersion medium S, there may be, for example, sol-gel, hydro gel, alginate gel, organogel or xerogel, gelatin, collagen, or the like. However, the cell dispersion medium is not limited thereto.

According to the embodiment of the present invention, the biomaterials C may be attached to the second substrate 120 in a three-dimensional structure in a state in which they are dispersed in the dispersion medium S. Since the biomaterial having the three-dimensional structure is more similar to a bio-environment, more accurate test results may be obtained.

The second substrate 120 may be made of a material having hydrophobicity, for example, a polymer. However, a material of the second substrate 120 is not limited thereto. As a specific kind of the polymer, for example, polystyrene (PS), polycarbonate (PC), polyethylene, poly(styrene-maleic anhydride) (PSMA), or the like, or a mixture thereof may be used. However, a kind of the polymer is not limited thereto. In addition, by adjusting a mixing ratio of the polymer, the second substrate may be formed to have desired characteristics.

A polymer having a maleic anhydride functional group has excellent binding capability with a biomaterial. When the second substrate 120 is formed by adjusting a ratio of the polymer having the maleic anhydride functional group, adhesion of the biomaterial may be improved.

As shown in FIG. 4, when the first and second substrates 110 and 120 are joined with each other, the biomaterials C formed on the second substrate 120 may be inserted into the micro wells 111 formed in the first substrate 110. The reagent M immersed in the micro well 111 may be supplied to the biomaterial C.

A culture medium needs to be continuously supplied to a cell in order to maintain a function of the cell, and a specific drug needs to be supplied to the biomaterial C in order to measure a reaction of the biomaterial C for the specific drug. By supplying the specific drug to the biomaterial, a toxicity test, an anti-cancer agent sensitivity and resistivity test, or the like, for new medicine development may be performed.

According to the embodiment of the present invention, the micro wells and the biomaterials may be arranged to have high integration on the first substrate or the second substrate. The biomaterials are formed to have high integration, whereby several diagnoses may be simultaneously performed, and the accuracy of a test result maybe improved. In addition, various kinds of biomaterials are present, such that characteristics of the biomaterials for the same drug may be tested or diagnoses may be simultaneously performed.

However, as intervals between the biomaterials and between the micro wells are reduced, the possibility that a reaction will be generated between adjacent biomaterials may increase, and cross-contamination between adjacent micro wells may occur. In addition, the hydrophilic first substrate 110 may have characteristics deteriorated due to the reagent M immersed in the micro well 111.

However, according to the embodiment of the present invention, the hydrophobic barrier layer may be formed on the hydrophilic first substrate.

Therefore, the plurality of micro wells may be physically shielded from each other and the possibility that the culture medium or the reagent will be diffused is low. In addition, penetration of the reagent between adjacent micro wells along the first substrate is prevented, whereby cross-contamination between the micro wells may be prevented and the possibility that a test error may occur may be reduced.

In addition, the reagent immersed in the micro well may be prevented from being absorbed by the first substrate 110.

The biochip according to the embodiment of the present invention is configured of the first and second substrates, wherein the first substrate may be made of a hydrophilic material and the second substrate may be made of a hydrophobic material according to respective use thereof. In addition, only the first or second substrate may be separately cleaned, and the culture medium and the reagent immersed in the micro wells may be periodically replaced.

FIG. 5 is a schematic cross-sectional view showing a biochip according to another embodiment of the present invention. Components different from components in the above-mentioned embodiment will mainly be described, and a detailed description of the same components will be omitted.

Referring to FIG. 5, a biochip according to this embodiment of the present invention may include a hydrophilic first substrate 210 and a hydrophobic second substrate 220, and the hydrophilic first substrate 210 may include a hydrophobic barrier layer 212 formed on a surface thereof.

The hydrophobic second substrate 220 may include a plurality of micro fillers 221 formed thereon at predetermined intervals. The micro fillers 221 may be formed at positions corresponding to positions of micro wells 211 formed in the first substrate 210.

The micro filler 221 refers to a structure protruding to a predetermined height from one surface of the second substrate 220 and maybe understood as a fine rod or a fine pin. The micro filler 221 may be a three-dimensional structure and have a biomaterial C attached to a protruding surface thereof.

The micro filler 221 may have various heights, for example, 50 to 500 μm. However, a height of the micro filler 221 is not limited thereto. In addition, the shapes of sectional and protruding surfaces of the micro filler are not specifically limited.

When the first and second substrates 210 and 220 are joined with each other, the micro fillers 221 formed on the second substrate 220 may be inserted into the micro wells 211 formed in the first substrate 210.

When the biomaterials C are formed on the micro fillers 221 as in the present embodiment, a combination ratio between the biomaterials C and the reagent M may be improved. In addition, the biomaterials C are attached to the protruding micro fillers 221, whereby the biomaterials C may be easily cleaned after various drug treatments.

The first substrate 210 may include the hydrophobic barrier layer 212 formed on the surface thereof. As shown in FIG. 5, the hydrophobic barrier layer 212 may be formed over the entire surface of the first substrate 210 in which the micro wells are formed. Therefore, the reagent M may be prevented from being absorbed by the first substrate 210. In addition, the possibility that the reagent M will be diffused between adjacent micro wells is low, and cross-contamination between the micro wells may be prevented.

As set forth above, in a biochip according to embodiments of the present invention, various reagents may be immersed in micro wells formed in a first substrate. When biomaterials are inserted into the micro wells, various reagents may be directly supplied to the biomaterials. Therefore, cells may be cultured, and the characteristics of the biomaterials according to the reagents may be analyzed, whereby various tests can be performed.

According to the embodiments of the present invention, the first substrate is made of a hydrophilic polymer, such that it may not be bent or deformed even in a severe temperature change. Therefore, even in the case that a test is performed in various temperature ranges, the accuracy of the test may not be deteriorated and measurement efficiency may be improved.

According to the embodiments of the present invention, the second substrate may be made of a hydrophobic material, whereby adhesion of the biomaterials may be improved.

According to the embodiments of the present invention, the micro wells and the biomaterials may be arranged to have high integration on the first substrate or the second substrate. The biomaterials are formed so as to have high integration, whereby several diagnoses may be simultaneously performed, and accuracy for test results may be improved. In addition, various kinds of biomaterials may be present, such that characteristics of the biomaterials for the same drug may be tested or diagnoses may be simultaneously performed.

According to the embodiments of the present invention, a hydrophobic barrier layer may be formed on the hydrophilic first substrate. Therefore, a plurality of micro wells may be physically shielded from each other, and the possibility that the culture medium or the reagent will be diffused is low. In addition, penetration of the reagent between adjacent micro wells along the first substrate is prevented, whereby cross-contamination between the micro wells may be prevented and the possibility that a test error will occur may be reduced. In addition, the reagent immersed in the micro well may be prevented from being absorbed by the first substrate.

According to the embodiments of the present invention, micro fillers may be formed on the second substrate. When the biomaterials are formed in the micro fillers, a combination ratio between the biomaterials and the reagent may be improved. In addition, the biomaterials are attached to the protruding micro fillers, whereby the biomaterials may be easily cleaned after various drug treatments.

While the present invention has been shown and described in connection with the embodiments, it will be apparent to those skilled in the art that modifications and variations can be made without departing from the spirit and scope of the invention as defined by the appended claims.

What is claimed is:

1. A biochip comprising:
a hydrophilic first substrate including a plurality of micro wells formed therein at predetermined intervals;
a hydrophobic barrier layer formed on a surface of the hydrophilic first substrate; and
a hydrophobic second substrate including biomaterials formed thereon, the biomaterials being inserted into the micro wells by joining the hydrophilic first substrate and the hydrophobic second substrate.

2. The biochip of claim 1, wherein the hydrophobic barrier layer comprises portions formed on portions of the surface of the hydrophilic first substrate.

3. The biochip of claim 1, wherein the hydrophobic barrier layer comprises a plurality of portions having a predetermined size and formed on the surface of the hydrophilic first substrate at predetermined intervals.

4. The biochip of claim 1, wherein the hydrophobic barrier layer comprises a plurality of portions having a predetermined size and formed between the micro wells.

5. The biochip of claim 1, wherein the hydrophobic barrier layer is formed over an entire surface of the hydrophilic first substrate in which the micro wells are formed.

6. The biochip of claim 1, wherein the hydrophilic first substrate is made of at least one polymer selected from the group consisting of polymethylmethacrylate, polycarbonate, and polyethylene.

7. The biochip of claim 1, wherein the hydrophobic second substrate is made of at least one polymer selected from the group consisting of polystyrene, polycarbonate, polyethylene, and poly(styrene-maleic anhydride).

8. The biochip of claim 1, wherein the biomaterials are present on the hydrophobic second substrate in a state in which the biomaterials are dispersed in a porous dispersion medium.

9. The biochip of claim 1, wherein the hydrophobic second substrate includes a plurality of micro fillers formed thereon at predetermined intervals, and
the micro fillers include the biomaterials formed on a surface thereof.
